(19) United States
(12) Patent Application Publication
(10) Pub. No.: US 2026/0362405 A1
(43) Pub. Date: Nov. 12, 2026

(54) WIRELESS ACCESS METHOD AND WIRELESS TERMINAL

(71) Applicant: NATIONAL INSTITUTE OF INFORMATION AND COMMUNICATIONS TECHNOLOGY, Koganei-shi, Tokyo (JP)

(72) Inventors: Michiharu NAKAMURA, Tokyo (JP); Takeshi MATSUMURA, Tokyo (JP); Hirokazu SAWADA, Tokyo (JP); Chang-Woo PYO, Tokyo (JP); Masafumi MORIYAMA, Tokyo (JP)

(73) Assignee: NATIONAL INSTITUTE OF INFORMATION AND COMMUNICATIONS TECHNOLOGY, Koganei-shi, Tokyo (JP)

(21) Appl. No.: 19/475,299

(22) PCT Filed: Mar. 12, 2024
(86) PCT No.: PCT/JP2024/009495

§ 371 Date: Oct. 14, 2025

(30) Foreign Application Priority Data
Apr. 14, 2023 (JP) 2023-066192

(51) Int. Cl. H04W 72/0453; H04W 72/02

(52) U.S. Cl. CPC H04W 72/0453; H04W 72/02

(57) ABSTRACT

A wireless access method for a plurality of wireless terminals to communicate by sharing a frequency that includes: identifying a radio resource on which reception is planned to be performed, and transmitting a packet including information relating to the identified radio resource as a control signal, by a first wireless terminal; and when a second wireless terminal has received the packet transmitted by the first wireless terminal and extracted the information of the radio resource on which the first wireless terminal plans to perform the reception, selecting one or a plurality of radio resources from remaining radio resources after removing the radio resource on which the first wireless terminal plans to perform reception from a selection range of radio resources to be transmitted, and performing transmission, by the second wireless terminal.

### TECHNICAL FIELD

The present invention relates to a wireless access method and a wireless terminal, in particular, relates to wireless communication between PCs, mobile terminals, IoT devices, and access points and wireless base stations connected thereto.

### BACKGROUND ART

A cellular wireless communication system that has been developed as a system that allows a voice call even while moving regardless of a location to which a telephone is connected via a telephone line is currently used not only for voice calls but also for using a wide variety of services that utilizes information communication. Furthermore, not only do humans use services with terminals at hand, but use in the industrial field such as remote operation of various sensors and industrial machines is also spreading.

On the other hand, a wireless local area network (LAN) developed for easily connecting a personal computer to a computer network at an office or home is also used when a wide variety of services utilizing information communication is used. In view of this, while the cellular wireless communication system and the wireless LAN have differences in the expansion of geographical locations where communication takes place and in contract forms to make communication available, there is no boundary from the viewpoint of using services utilizing information communication.

While the services utilizing information communication used to be achieved by transmitting and receiving short character information at the beginning, they have expanded to transmit and receive images, music data, and moving image data, in particular, in recent years, to transmit more detailed, higher image quality moving image data and virtual reality environments, and the amount of data to be communicated is continuously increasing. In addition, a demand for connecting a large number of devices at once is also increasing.

Up to the present, the cellular wireless communication system and the wireless LAN have handled an increased communication data amount by introducing a technique that uses higher-order modulation schemes, and increases the amount of data transmittable per unit frequency width of a radio wave, such as a Multi-Input Multi-Output (MIMO) channel that uses multiple antenna elements, and increasing the frequency bandwidth used by the system.

Here, the amount of data transmittable per unit frequency width of a radio wave has an upper limit corresponding to electric power of a signal, and an absolute amount of energy permitted to be radiated as a radio wave is in some cases restricted due to safety reasons and a demand for greening of the whole communication system. In addition, it is difficult to increase the amount of data transmittable per unit frequency width of a radio wave to the current state or more in a situation where electric power permitted to be consumed for communication is restricted.

Accordingly, it is necessary to increase the frequency bandwidth used by the system; however, it is difficult to newly secure a frequency band available for a cellular wireless communication system or a wireless LAN at a frequency equal to or less than approximately 6 GHz at which existing radio wave utilization systems, such as positioning or sensing by broadcasting or satellites, meteorological radars, police or fire department radios, aeronautical or ship radios, and amateur radios, concentrate.

Therefore, it has been examined to use a millimeter wave that indicates a radio wave with a frequency of approximately 10 GHz to 100 GHz, a sub-terahertz wave exceeding 100 GHz, and a terahertz wave reaching 1 THz to 10 THz for the cellular wireless communication system and the wireless LAN. 3GPP (registered trademark) has formed a cellular wireless communication standard that mainly uses a millimeter wave in the 28 GHz band, and has been partially put to practical use. IEEE has formed a technical standard, such as a wireless LAN specification 802.11ad or 802.11ay that uses the 60 GHz band, and 802.15.3d that communicates in a point-to-point manner using the 300 GHz band. With these millimeter wave, sub-terahertz wave, and terahertz wave, a substantial amount of bandwidth is available at once. For example, with the IEEE 802.11ay standard, based on the 2.16 GHz bandwidth, the 8.7 GHZ bandwidth obtained by bundling four 2.16 GHz bandwidths is available, and with the 802.15.3d standard, the 69 GHz bandwidth obtained by bundling a maximum of thirty-two 2.16 GHz bandwidths is available. Such a wide bandwidth cannot be ensured at a frequency equal to or less than 10 GHZ.

According to the Friis transmission formula, received power Pr at a reception end when a radio wave propagates in free space is expressed as Pr=(λ/4πd)²·Gᵣ·Gₜ·Pₜ. λ, d, Gᵣ, Gₜ, and Pₜ are a wavelength of the radio wave, a distance between transmission and reception points, directional gain of a receiving antenna, directional gain of a transmitting antenna, and transmission electric power, respectively. Since the wavelength shortens in inverse proportion to the frequency, the received power weakens in inverse proportion to the square of the frequency. While it is known that for a propagation path that is not free space, such as inside a room and on a street, the received power statistically deviates from the inverse-square law in some cases, the fact that the received power weakens at a value close to the square of the frequency remains. Accordingly, in communication that uses a high frequency, it is necessary to compensate for a decrease in the received power by using an antenna with high directional gain at one or both of sides that mutually perform transmission and reception. The antenna with high directional gain is an antenna that radiates a radio wave in a certain direction in a concentrated manner or intensely receives a radio wave arriving from a certain direction, and on the other hand, weakens the intensity of radio waves radiated in or received from the other directions.

Most of the cellular wireless communication systems are based on a licensing system for the radio wave frequency band they use, and a permitted business operator exclusively uses a provided frequency band and establishes and operates a wireless communication system. The cellular wireless communication system specifies both individual frequency resources obtained by dividing the frequency band permitted to be used into smaller pieces and a time slot in which the frequency resource is used to use them as a radio resource, and a wireless base station provided for each specific area manages and controls the use of the radio resource in the area. On the other hand, most of the wireless LANs are used in a frequency band that does not require a license (unlicensed band), and employ a Carrier Sense Multiple Access-Collision Avoidance (CSMA-CA) method. A terminal and an access point monitor the usage condition of a radio wave in the frequency band immediately before a radio resource on which communication is to be attempted, and when it is determined that no other party is using the radio wave, the communication is made.

While it has been described that, in the cellular wireless communication system, the wireless base station controls the use of the radio resource in the area, 3GPP (registered trademark) has set the Cellular V2X (CV2X) standard that has incorporated a radio resource control method in which terminals intended to be mounted on a vehicle autonomously monitor the usage condition of a radio wave and determines a radio resource to be used to perform transmission and reception without being controlled by the base station in LTE Release 14 or NR Release 16 (see Non-Patent Literature 1). In this radio resource control method, as illustrated in FIG. 11, when the terminal selects a radio resource in a selection window and performs transmission, control information of communication performed by another terminal is monitored in a sensing window that precedes the transmission. This piece of control information includes reservation information of a radio resource to be used next by the terminal that has transmitted the control information, and when the radio resource to be used next is a radio resource in the selection window, the terminal finds that selecting the radio resource and performing transmission is likely to cause a conflict. Therefore, the terminal selects a radio resource used for the transmission among radio resources without reservation information and performs the transmission.

Patent Literature 1 discloses that when another terminal further sends reservation information for a radio resource that already has reservation information, a third terminal that has received both pieces of the reservation information notifies the terminal that has sent the overlapping reservation information. Even when the radio resource reservation information fails to be obtained for some reasons, sending reservation information for the radio resource selected by the terminal itself allows finding resource contention through the third terminal, which allows avoiding a conflict when the transmission is performed on the selected radio resource.

In the CSMA-CA method employed by the wireless LAN, reservation information of a radio resource is not transmitted, but all terminals that attempt to perform transmission monitor the usage condition of a radio wave in the frequency band immediately before a radio resource on which the transmission is attempted and perform the transmission when the radio wave is available. A time period for which the usage condition of the radio wave is monitored is randomly set, and when a terminal that sets a short time period starts to perform the transmission earlier, another terminal detects that the radio wave is not available and suspends the transmission to avoid a conflict with the preceding transmission.

The wireless LAN further has a function of avoiding a conflict using a Request to send (RTS) signal and a Clear to send (CTS) signal (FIG. 12). The terminal that attempts to transmit data firstly transmits an RTS signal, not data, to a counterpart terminal when monitoring the usage condition of the radio wave and determining that the radio wave is available. The counterpart terminal that has received the RTS signal returns a CTS signal when the data is receivable. The CTS signal is received, and then the data is transmitted.

The RTS signal and the CTS signal have a function of solving a hidden node problem. The hidden node problem is a problem in which, for example, when a terminal C illustrated in FIG. 13 monitors the usage condition of a radio wave so as to attempt to perform transmission, and when a radio wave of a terminal B that is performing transmission is not received by a terminal C for a reason that the distance is far, an obstacle is present on the way, or the like, the terminal C starts the transmission by misrecognizing that the radio resource is available, which causes a conflict with the radio wave transmitted by the terminal B in the terminal A as a communication destination, and thus, successful reception is hindered.

The hidden node problem is not only caused by the distance or an obstacle but also may be caused by the use of a directional antenna. As illustrated in FIG. 14, the radio wave transmitted with a directivity directed to the terminal A by the terminal B is less likely to be received by the terminal C when the terminal C is outside of the directivity of the transmission performed by the terminal B even though no obstacle is present between the terminal B and the terminal C or the distance is relatively close. Therefore, the terminal C that fails to receive the radio wave transmitted by the terminal B misrecognizes that the radio resource is available, and when the transmission is performed with a directivity that may have an effect on the terminal A, a conflict with the radio wave transmitted by the terminal B is caused in the terminal A.

While a RTS signal is transmitted when the usage condition of the radio wave is monitored and a determination that the radio wave is available is made, when the RTS signal has a conflict and is not received by the terminal A, the terminal A does not return a CTS signal, and therefore, the terminal C does not start to transmit data, which does not cause data loss. When the RTS signal is received by the terminal A and the return of the CTS signal is detected, the terminal C starts to transmit the data.

The CTS signal transmitted in response to the RTS signal and furthermore the data transmitted in response to the CTS signal are transmitted after a time interval that is referred to as a Short Inter Frame Space (SIFS) and that is shorter than usual. This prevents a third terminal from determining that the radio wave is available and cutting in during a SIFS time period.

The RTS signal and the CTS signal include information indicative of the duration of occupancy of the radio wave referred to as the Network Allocation Vector (NAV), which allows telling that the radio wave is not available for a certain period of time after the transmission of the RTS signal or the CTS signal. In the case where the RTS signal or the CTS signal is not used, when the terminal C fails to receive data due to the hidden node problem while the terminal B is transmitting the data, the terminal C misrecognizes that the radio wave is available, but the terminal A as the communication destination of the terminal B can recognize that the radio wave is not available from the NAV information included in the CTS signal when the hidden node problem is not present and the CTS signal is received, and therefore, a conflict of the radio wave is avoidable.

### CITED DOCUMENTS

### Patent Literature

Patent Literature 1: WO 2022/097291

### Non-Patent Literature

Non-Patent Literature 1: M. H. C. Garcia et al., “A Tutorial on 5G NR V2X Communications,” in IEEE Communications Surveys & Tutorials, vol. 23, no. 3, pp. 1972-2026, third quarter 2021

### DISCLOSURE OF THE INVENTION

### Problems to be Solved by the Invention

When the radio resource control in accordance with C-V2X is performed, the hidden node problem similar to the CSMA/CA method without using the RTS signal or the CTS signal is caused. That is, when a radio wave transmitted by a certain terminal (assumed as B) is not received by another terminal (assumed as C), radio resource reservation information transmitted by the terminal B is not received by the terminal C, and therefore, when the terminal C selects this radio resource and performs transmission, a conflict is caused.

In the Patent Literature 1 described above, a terminal C firstly transmits reservation information of a selected radio resource, and a third terminal that detects a contention with reservation information of a radio resource transmitted by a terminal B notifies the terminal C of the contention of the reservation information of the radio resource, and thus, the terminal C can find the contention of the radio resource, thereby allowing the avoidance of a conflict. However, in this method, the terminal C transmits the reservation information of the radio resource before the radio resource subject to the contention reaches, a sufficient time to receive the notification about the contention of the reservation information of the radio resource from the third terminal is needed, and it is also necessary to secure a radio resource for performing these transmission and notification.

When there is a hidden node problem in the case where, when the radio resource control in accordance with C-V2X is performed, the RTS signal and the CTS signal in the wireless LAN are used in combination, and data is transmitted when the terminal B sends the RTS signal and receives the CTS signal from a terminal (assumed as A) as a counterpart, since the actual data transmission performed by the terminal B is not within a certain period of time after the RTS signal or the CTS signal but follows the radio resource reservation information by the terminal B even though the CTS signal transmitted by the terminal A is successfully received, the third terminal (assumed as C) that fails to receive the radio wave of the terminal B does not know the radio resource when it fails to receive the reservation information of the radio resource from the terminal B, and therefore, the terminal C fails to perform transmission avoiding a conflict.

The present invention has been invented in consideration of the above-described problems, and an object of the present invention is to provide a wireless access method and a wireless terminal capable of avoiding a hidden node problem and achieving efficient wireless channel access for a wireless access method in unlicensed bands in a millimeter wave and a THz wave in which a directional antenna is frequently used.

### Solutions to the Problem

In order to solve the above-described problems, a wireless access method according to the present invention adopts the following configuration.

A wireless access method according to a first invention is a wireless access method for a plurality of wireless terminals to communicate by sharing a frequency. The wireless access method includes: identifying a radio resource on which reception is planned to be performed, and transmitting a packet including information relating to the identified radio resource as a control signal, by a first wireless terminal; and when a second wireless terminal has received the packet transmitted by the first wireless terminal and extracted the information of the radio resource on which the first wireless terminal plans to perform the reception, selecting one or a plurality of radio resources from remaining radio resources after removing the radio resource on which the first wireless terminal plans to perform the reception from a selection range of radio resources to be transmitted, and performing transmission, by the second wireless terminal.

In the wireless access method according to a second invention, which is in the first invention, directivity of an antenna used when the first wireless terminal generates and transmits the transmission packet including the information relating to the radio resource on which the reception is planned to be performed as the control signal is identical or equivalent to directivity of an antenna planned to be used when the reception is performed on the radio resource on which the reception is planned to be performed.

In the wireless access method according to a third invention, which is in the first invention or the second invention, the directivity of the antenna planned to be used when the reception is performed on the radio resource on which the reception is planned to be performed by the first wireless terminal is a directivity directed to a counterpart of communication of the first wireless terminal.

A wireless terminal according to a fourth invention is a wireless terminal that communicates with another wireless terminal by sharing a frequency. The wireless terminal: sets a range from which a radio resource for transmitting a packet is selected and a radio resource range for receiving a packet including information relating to a radio resource on which the other wireless terminal performs transmission as a control signal to detect presence/absence of a radio resource on which the other wireless terminal plans to perform reception among radio resources within the selection range of the radio resource for transmitting the packet; performs the reception in the radio resource range for receiving the packet including the information relating to the radio resource as the control signal; removes the detected radio resource on which the other wireless terminal plans to perform the reception from the selection range of the radio resources for transmission; selects one or a plurality of radio resources from the remaining radio resource selection range; and transmits the packet on the selected radio resource.

In the wireless terminal according to a fifth invention, which is in the fourth invention, the wireless terminal generates and transmits a transmission packet including information relating to a radio resource on which reception is planned to be performed as a control signal when transmitting the packet.

In the wireless terminal according to a sixth invention, which is in the fifth invention, directivity of an antenna used when the transmission packet including the information relating to the radio resource on which the reception is planned to be performed as the control signal is generated and transmitted is identical or equivalent to directivity of an antenna planned to be used when the reception is performed on the radio resource on which the reception is planned to be performed.

### Effects of the Invention

According to the first invention to the sixth invention having the above-mentioned configurations, for a wireless access method in unlicensed bands in a millimeter wave and a THz wave in which a directional antenna is frequently used, a wireless access method and a wireless terminal capable of avoiding a hidden node problem and achieving efficient wireless channel access are achievable.

According to the first invention to the sixth invention having the above-mentioned configurations, when a third wireless terminal that is other than the first wireless terminal and the second wireless terminal attempting to transmit data to the first wireless terminal monitors communication being already performed in a sensing window for searching for a usable radio resource in a selection window, and collects reservation information of the radio resource, the radio resource on which the second wireless terminal attempts to perform transmission is identifiable in the selection window when “information of a radio resource planned to be received” transmitted by the first wireless terminal is receivable even when “reservation information of a radio resource on which transmission is performed next” transmitted by the second wireless terminal is not receivable due to the hidden node problem. Therefore, the third wireless terminal is capable of avoiding selecting this radio resource when performing the transmission, and a packet conflict is avoidable. The packet conflict is an issue at the time point of performing reception, and therefore, the “information of the radio resource planned to be received” by the first wireless terminal that performs the reception is more effective than the “reservation information of the radio resource on which transmission is performed next” by the second wireless terminal that performs the transmission. This is because even when the third wireless terminal performs the transmission on a radio resource with the “reservation information of the radio resource on which transmission is performed next” by the second wireless terminal that performs the transmission, there is a possibility that a receiver has no issue depending on a positional relation of the wireless terminals or a directivity used for transmission and reception, but being able to receive the “information of the radio resource planned to be received” by the first wireless terminal that performs the reception means that it is highly possible to have an effect on the receiver when the transmission is performed there.

The “information of the radio resource planned to be received” by the first wireless terminal that performs the reception effectively works when it is transmitted with the same directivity as a directivity used when the reception is performed on the planned radio resource or an equivalent directivity thereto. When the third wireless terminal receives the “information of the radio resource planned to be received,” the wireless terminal is considered to be in a range of the directivity used when the wireless terminal that has sent the information performs the reception on the planned radio resource, and highly possibly has an effect on the reception. On the other hand, when being outside the range of the directivity of the wireless terminal that has sent the information, the wireless terminal that has not received the information has no effect on the reception of the wireless terminal that has sent the information even though performing the transmission by recognizing the resource as available, and thus, it is considered that the radio resource is effectively utilized.

### BRIEF DESCRIPTION OF THE DRAWINGS

FIG. 1(a) is a block diagram of an inter-wireless-terminal wireless access system to which the present invention is applied.

FIG. 1(b) is another block diagram of the inter-wireless-terminal wireless access system to which the present invention is applied.

FIG. 2 is a drawing for describing the addition of radio resource information planned for reception in Embodiment 1.

FIG. 3 is a block configuration diagram of a wireless terminal for executing the present invention.

FIG. 4 is a drawing illustrating a processing flow of the wireless terminal when transmission data is generated in Embodiment 1.

FIG. 5 is a drawing for describing the addition of the radio resource information planned for reception in Embodiment 1.

FIG. 6 is a drawing illustrating a processing flow of the wireless terminal when reception is performed in a sensing window in Embodiment 1.

FIG. 7 is a processing flow of a terminal when the radio resource information for performing reception for executing the present invention is held.

FIG. 8 is a drawing for describing the addition of radio resource information planned for reception in a fourth embodiment.

FIG. 9 is a drawing for describing the addition of radio resource information planned for reception in a fifth embodiment.

FIG. 10 is a block configuration diagram of a wireless terminal for executing the fifth embodiment.

FIG. 11 is a drawing for describing radio resource selection in C-V2X.

FIG. 12 is a drawing for describing avoiding a conflict caused by a RTS signal/CTS signal.

FIG. 13 is a conceptual diagram illustrating a hidden node problem.

FIG. 14 is a conceptual diagram illustrating a hidden node problem when a directional antenna is used.

### DESCRIPTION OF PREFERRED EMBODIMENTS

The following describes a wireless access method and a wireless terminal (wireless access system) to which the present invention is applied in detail with reference to the drawings.

### First Embodiment

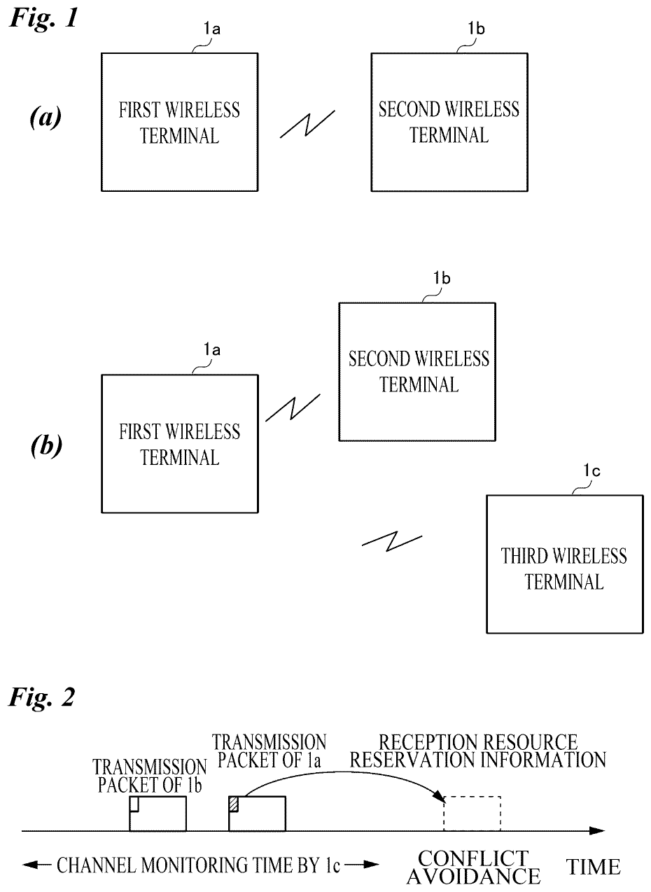

FIG. 1(a) and FIG. 1(b) are drawings illustrating an overall configuration of an inter-wireless-terminal wireless access system to which the present invention is applied. FIG. 1(a) illustrates an example in which there are a first wireless terminal 1a as one transmission terminal, and a second wireless terminal 1b as one reception terminal. FIG. 1(b) illustrates an example in which there are a plurality of reception terminals, the second wireless terminal 1b and a third wireless terminal 1c.

This wireless access system includes the first wireless terminal 1a and the second wireless terminal 1b or the third wireless terminal 1c as illustrated in FIG. 1(a) or FIG. 1(b). While in the following example, a description will be given using a case of a configuration having one first wireless terminal 1a and one second wireless terminal 1b as an example, the configuration is not limited to this, and a case of a configuration having three or more wireless terminals is included.

The first wireless terminal 1a and the second wireless terminal 1b correspond to terminals in various configurations. Here, the terminal is any electronic device wirelessly communicable between the first wireless terminal 1a and the second wireless terminal 1b, and a communication location changes by the movement of a person who carries, for example, a smartphone, a mobile terminal, a mobile PC, a wearable device, a tablet terminal, or an IoT device, or the movement of a moving body in which the terminal (for example, an IoT device) is mounted.

The first wireless terminal 1a and the second wireless terminal 1b mainly consider wireless access in an unlicensed band in a millimeter wave or a terahertz wave (THz wave) in which a directional antenna (a beam antenna) is frequently used, but may use in combination with wireless access that uses a wireless base station of a cellular wireless communication system or a wireless access point in a wireless LAN. The first wireless terminal 1a and the second wireless terminal 1b can wirelessly communicate with another wireless terminal in a mutual manner.

A wireless access method between the wireless terminals in Embodiment 1 in such a configuration of the communication system will be described.

In Embodiment 1, in the wireless access system configuration illustrated in FIG. 1(b), when the second wireless terminal 1b transmits a transmission packet, and the first wireless terminal 1a transmits a transmission packet, as illustrated in FIG. 2, adding reception resource reservation information of a radio resource to the transmission packet of the first wireless terminal 1a allows the third wireless terminal 1c that fails to receive a signal of the second wireless terminal 1b within a channel monitoring time by the third wireless terminal 1c to receive a signal of the first wireless terminal 1a and avoid transmission on a target resource, thereby allowing avoiding a hidden node problem and achieving efficient wireless access.

The following describes a principle of the wireless access method of Embodiment 1 in detail. Since a conflict or an interference of packets is an issue of a wireless terminal on a receiving side, the wireless terminal on the receiving side provides reception resource reservation information of a radio resource based on a concept that the wireless terminal on the receiving side providing information is rational. That is, the reservation information of the radio resource to be used next is sent by a wireless terminal planned to receive a radio wave using the radio resource. For example, while data is being transmitted from the second wireless terminal 1b to the first wireless terminal 1a, the first wireless terminal la can identify the radio resource on which the second wireless terminal 1b performs transmission next from the radio resource reservation information transmitted by the second wireless terminal 1b, and therefore, the first wireless terminal 1a transmits the information of the radio resource planned to be received according to such information. Alternatively, when radio resource control in which the first wireless terminal 1a instructs the second wireless terminal 1b in the radio resource to be used by the second wireless terminal 1b for transmission is performed, the first wireless terminal 1a recognizes the radio resource planned to be received by the first wireless terminal 1a itself, and therefore, such information only needs to be transmitted. The information of the radio resource on which the first wireless terminal 1a plans to receive data from the second wireless terminal 1b can be added and transmitted when the first wireless terminal la transmits data toward the second wireless terminal 1b. When a directional antenna is used in this transmission, the transmission only needs to be performed with a directivity toward the second wireless terminal 1b. This directivity is usually the same as a directivity that should be used in the reception of data from the second wireless terminal 1b in the radio resource planned to be received when the sources that cause errors are removed. The information of the radio resource on which data from the second wireless terminal 1b is planned to be received can be transmitted alone, instead of adding it to the transmission of the data toward the second wireless terminal 1b and performing transmission. When the directional antenna is used in this transmission, a directivity planned to be used in reception of data from the second wireless terminal 1b only needs to be used. This is usually the same as a directivity used when the data is transmitted to the second wireless terminal 1b when the sources that cause errors are removed.

### <Embodiment 1 Wireless Terminal Configuration>

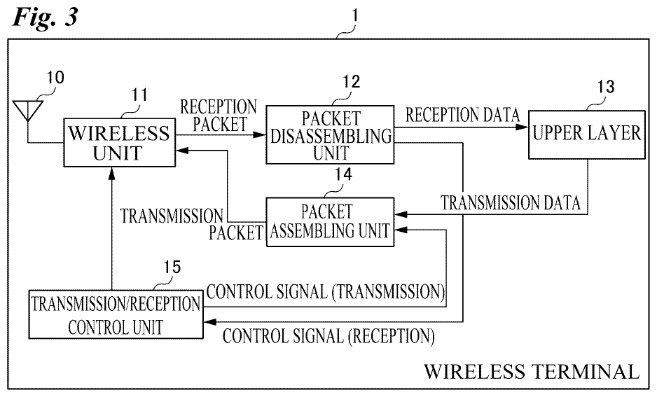

FIG. 3 is a block configuration diagram of a wireless terminal 1 (including 1a, 1b, 1c). Note that the block configuration diagram illustrated in this FIG. 3 illustrates components that are the minimum necessary for producing an expected effect of the present invention, and does not illustrate other components for operating as the wireless terminal.

The wireless terminal 1 used in Embodiment 1 has a transmission/reception antenna 10, a wireless unit 11, a packet disassembling unit 12, an upper layer 13, a packet assembling unit 14, and a transmission/reception control unit 15 as illustrated in FIG. 3.

### <Embodiment 1 Wireless Terminal Description of Configuration>

The transmission/reception antenna 10 is a directional antenna that has a directivity and transmits and receives a signal. In a THz band, the directional antenna is used because signal strength is not obtainable unless a sufficient directional antenna is used. When a wireless device is a terminal, a response is basically made while a beam of a wireless access point is directed at the wireless device itself. In 5G, a synchronization signal is transmitted per beam.

The wireless unit 11 performs amplification of a wireless signal, conversion of a frequency, extraction of a necessary frequency component, modulation and demodulation, and the like. The wireless unit 11 takes out a reception packet from a received wireless signal, or converts a transmission packet into a wireless signal to be transmitted. In addition, the wireless unit 11 performs signal processing when the directivity of the transmission/reception antenna 10 is controlled by signal processing of transmission and reception signals by a plurality of antenna elements.

The packet disassembling unit 12 separates reception data and a control signal (reception) from the reception packet. The reception data is transmitted to the upper layer 13 as a communication content.

The upper layer 13 uses communication data (reception data or transmission data) in an application.

The packet assembling unit 14 assembles the transmission data received from the upper layer 13 as a transmission packet together with the control signal (transmission).

The transmission/reception control unit 15 controls the wireless unit 11 such that a predetermined wireless signal is transmitted/received on a predetermined radio resource in accordance with a standard, a parameter determined in advance, a control signal in the reception packet, and the like. The transmission/reception control unit 15 controls a frequency or a bandwidth of the radio wave to be used, a timing at which the wireless unit 11 is operated for transmission and reception, transmission electric power, an amplification degree of a receiver, and a directivity that the transmission/reception antenna 10 should have. While an antenna unit is not illustrated in FIG. 3, when the directivity of the transmission/reception antenna 10 is achieved by the antenna unit, not by the signal processing of the wireless unit 11, the directivity control is performed on the antenna unit.

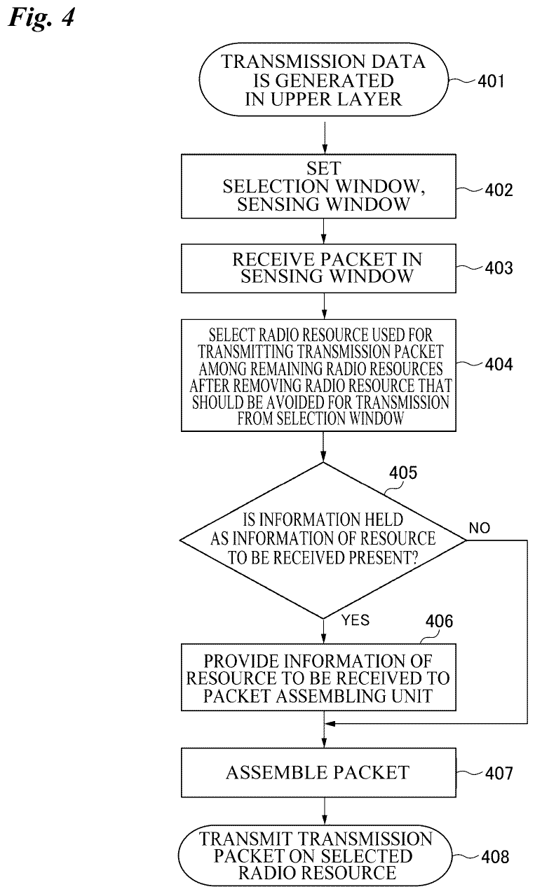

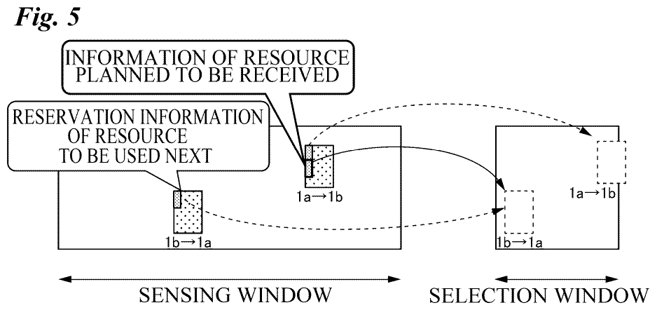

FIG. 4 is a processing flow of the wireless terminal when transmission data is generated. When data that should be transmitted is generated in the upper layer (Step 401), a selection window that is a range of selecting a radio resource on which transmission is performed and a sensing window in which reception for checking the presence/absence of a reservation of the radio resource in the selection window is performed are set (Step 402). At Step 402, as soon as the transmission data is generated, the sensing window is started, and the radio resource after securing the minimum necessary reception time can be set as the selection window. FIG. 5 illustrates a relation example between the sensing window and the selection window described above.

Next, the packet in the sensing window is received (Step 403), and then, a radio resource used for transmitting a transmission packet is selected among remaining radio resources after removing radio resources that should be avoided for transmission from the selection window (Step 404).

Next, the presence of information held as information of a resource to be received is checked (step 405). When the held reception resource information is present (step 405), the information of the resource to be received is provided to the packet assembling unit 14 (Step 406). In the packet assembling unit 14, the packets are assembled (Step 407). The transmission packet is transmitted on the selected radio resource (Step 408).

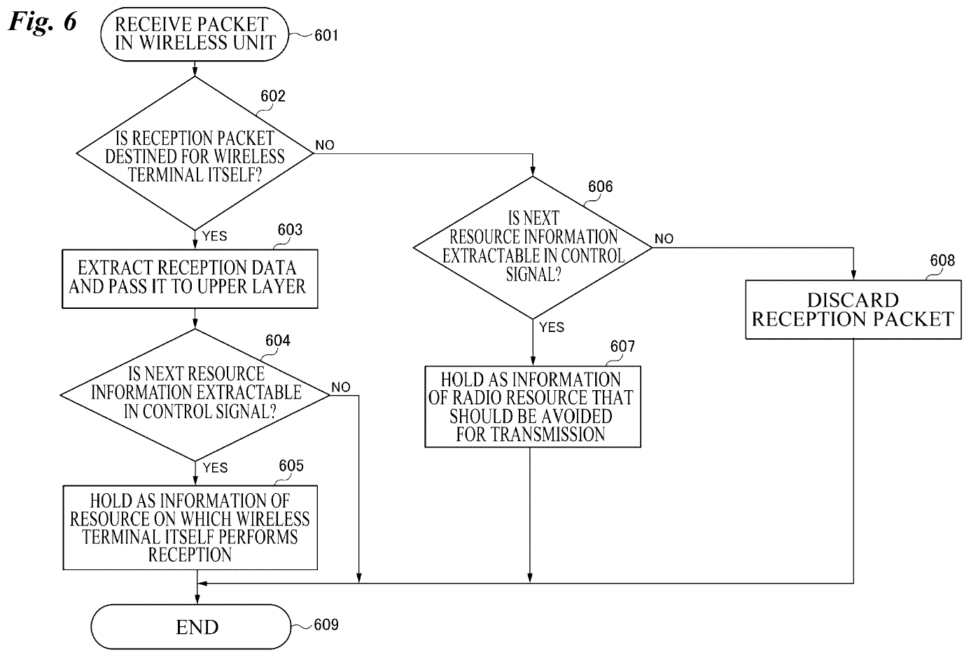

FIG. 6 is a processing flow of the wireless terminal when reception is performed in the sensing window. A packet is received in the sensing window (Step 601), and whether the reception packet is destined for the wireless terminal or not is determined (Step 602). When the reception packet is destined for the wireless terminal, the reception data is extracted and passed to the upper layer 13 (Step 603), and whether the next resource information is extractable in the control signal or not is determined (Step 604). When the information of a radio resource planned to be transmitted next is obtained in the control signal (Step 604), it is the radio resource that should be received next, and is included in a control signal that transmits the information, and therefore, is held as information of the resource on which the wireless terminal itself performs reception (Step 605), and when the information of the radio resource planned to be transmitted next is not obtained, the reception packet is transmitted to be discarded (Step 608). When the reception packet is not destined for the wireless terminal (Step 602), whether the next resource information is extractable in the control signal or not is determined (Step 606). When the information of the radio resource planned to be transmitted next is obtained in the control signal (Step 606), the information of the radio resource used next extracted from the control signal is held as the information of the radio resource that should be avoided for transmission (Step 607), and the process is terminated (Step 609). When the information of the radio resource planned to be transmitted next is not obtained in the control signal (Step 606), the reception packet is discarded (Step 608), and the process is terminated (Step 609). The radio resource indicated by this piece of information has two patterns, the case of the radio resource planned to be transmitted next by a transmitter and the case of the radio resource planned to be received. In any case, it is the information of the radio resource that should be avoided for transmission in the selection window. When reception is performed in the sensing window, and the information of the radio resources that should be avoided for transmission is obtained in the selection window, those radio resources are removed from the radio resources in the selection window, and the radio resource to be used for transmission is selected from the remaining radio resources. This selection only needs to be performed in a random manner. The transmission packet is transmitted using the selected radio resource. The transmission packet is generated by the packet assembling unit 14 using transmission data and a control signal including the information of the radio resource planned to be received next.

### Second Embodiment

In the case where the information of the radio resource that should be received next is present even when transmission data is not generated in the upper layer 13 (see FIG. 5), a wireless terminal in a second embodiment is capable of transmitting a packet in which the information of the radio resource that should be received next is a control signal in addition to the operation of the wireless terminal indicated in the first embodiment. This wireless terminal performs a reception operation always or in a time slot in which the reception operation is determined to be performed, and when the wireless unit 11 receives a packet, the operations in accordance with the flow in FIG. 6 is performed.

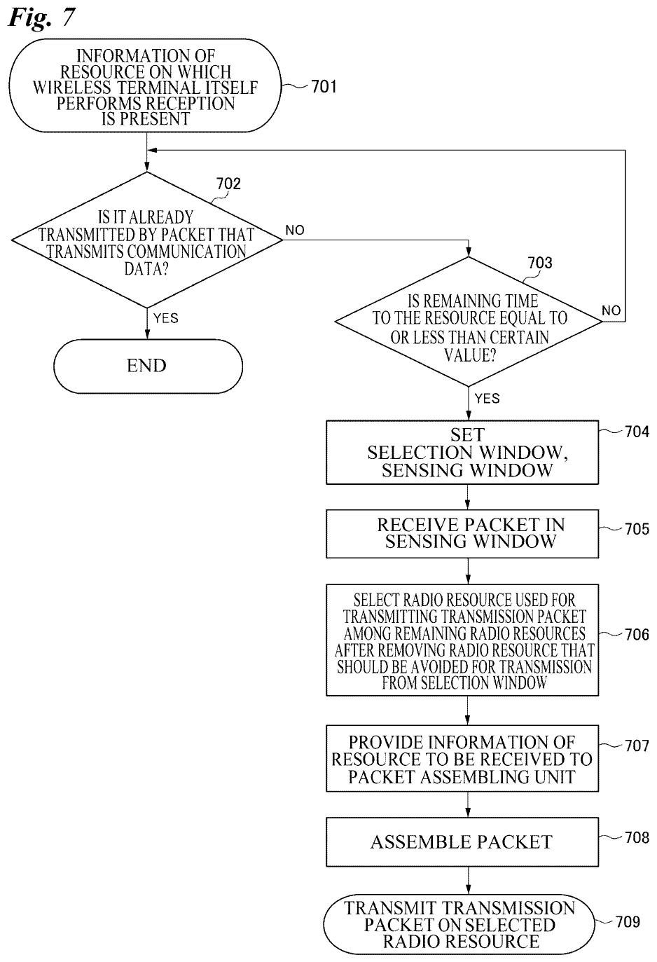

FIG. 7 is a processing flow of the wireless terminal when the information of the radio resource to be received for executing the present invention is held. The following describes the process of the wireless terminal holding the information of the radio resource to be received using the flow in FIG. 7

When the information of the radio resource planned to be transmitted next is extracted in the control signal of the packet destined for the wireless terminal, the information of the radio resource planned to be transmitted next is held as the information of the radio resource planned to be received, and the processing flow in FIG. 7 is activated.

When the information of the resource on which the wireless terminal itself performs reception is present (Step 701), whether the information of the resource on which the wireless terminal itself performs reception is already transmitted by the packet that transmits communication data or not is determined (Step 702), and whether a remaining time to the resource is a certain value or less is determined (Step 703). That is, the information of the radio resource planned to be received does not immediately transmit the transmission packet including the information of the radio resource planned to be received as the control signal, but stands by until the remaining time to the radio resource decreases to equal to or less than a certain value. When the transmission data is generated during it, the operation in accordance with the processing flow illustrated in FIG. 7 of the first embodiment is performed, and the transmission packet having the control signal including the information of the radio resource planned to be received is transmitted.

When less than a certain period of time is left to the radio resource planned to be received without the generation of the transmission data (Step 703), an operation for transmitting the transmission packet including the information of the radio resource planned to be received in the control signal is initiated even though the transmission data is not present. The certain period of time is set so as to be able to transmit the control signal on the radio resource present in the sensing window set when the radio resource planned to be received is available in the selection window (Step 704). The packet in the sensing window is received (Step 705), and then, when the radio resource on which the control signal is transmitted is also selected among the radio resources without the reservation information (Step 706), the time period including a sensing window time for receiving the reservation information is set.

The information of the resource to be received is provided to the packet assembling unit 14 (Step 707). The transmission packet generates the control signal including the information of the radio resource planned to be received in the packet assembling unit 14 (Step 708). The control signal may also include the information other than the information of the radio resource planned to be received. In the radio resource selected last, the generated transmission packet is transmitted (Step 709).

### Third Embodiment

The wireless terminal in the first embodiment or the second embodiment receives a packet destined for the wireless terminal, identifies the radio resource planned to be received next from the information of the radio resource on which the reception packet destined for the wireless terminal is planned to be transmitted next included in the control signal in the packet destined for the wireless terminal, and includes the information in the control signal in the transmission packet transmitted by the wireless terminal itself. When the wireless terminal itself specifies the radio resource on which the counterpart of the communication performs transmission for the counterpart of the communication, a wireless terminal in a third embodiment holds the resource to be specified as the information of the radio resource planned to be received next, and thus, is capable of including the radio resource information in the control signal in the packet to be transmitted and transmitting the radio resource information in accordance with the processing flow in FIG. 7 or FIG. 9.

### Fourth Embodiment

In the cellular wireless communication system or the wireless LAN, an antenna with a directivity is used to increase the intensity of a desired signal or reduce the intensity of an interference signal, thus attempting the improvement in communication quality. In particular, when a radio wave with a high frequency equal to or higher than a millimeter wave is used, degradation of received signal strength in which the radio wave weakens in inverse proportion to the square of the frequency is compensated for using the antenna with a directivity.

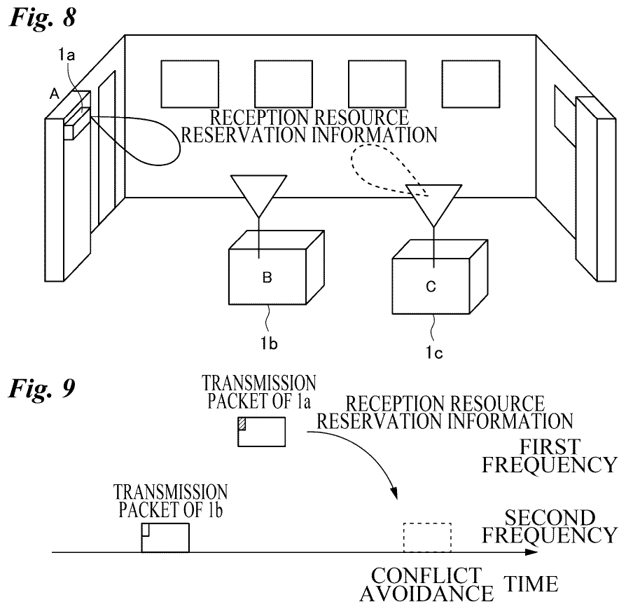

As illustrated in FIG. 8, when a wireless terminal in a fourth embodiment transmits the transmission packet made of the control signal including the transmission data and the information of the radio resource planned to be received next to a wireless terminal as a counterpart of communication, it performs transmission with a directivity so as to be properly received in the wireless terminal as the counterpart of communication. The directivity is usually a directivity toward a direction in which the wireless terminal as the counterpart of communication is present. In this respect, a wireless terminal present in a location to which the directivity is not directed may fail to receive the information of the radio resource planned to be received next and determine that this radio resource is available. Therefore, the transmission packet with the control signal including the information of the radio resource planned to be received next may be generated, added to the transmission packet including the transmission data, and transmitted with a directivity other than the directivity. This may be transmitted with one or a plurality of directivities close to the directivity used to transmit the transmission packet including the corresponding transmission data, or more transmission packets may be generated to cover every direction, and transmitted using more directivities. When an omnidirectional antenna is available, the transmission may be performed using the omnidirectional antenna.

When no transmission data to be transmitted to the wireless terminal as the counterpart of communication is present, but the packet is planned to be received from the counterpart wireless terminal, and therefore, the transmission packet including the control signal that does not include the transmission data but includes the information of the radio resource planned to be received next is transmitted, this transmission packet only needs to be transmitted using the directivity planned to be used when the packet is received from the counterpart wireless terminal. It is highly possible that an interference is caused when a wireless terminal present in the directivity planned to be used for reception performs transmission. Therefore, transmitting the transmission packet including the control signal including the information of the radio resource planned to be received next in this direction allows efficiently delivering the information of the radio resource planned to be received to such a wireless terminal.

The transmission packet including the control signal including the information of the radio resource planned to be received next may be transmitted using one or the plurality of close directivities or the omnidirectional antenna as described above.

### Fifth Embodiment

A wireless access method in a fifth embodiment handles two frequencies as illustrated in FIG. 9, and therefore, employs a configuration of having two wireless functions, and adding reception resource reservation information using the different wireless functions.

### <Embodiment 5 Wireless Terminal Configuration>

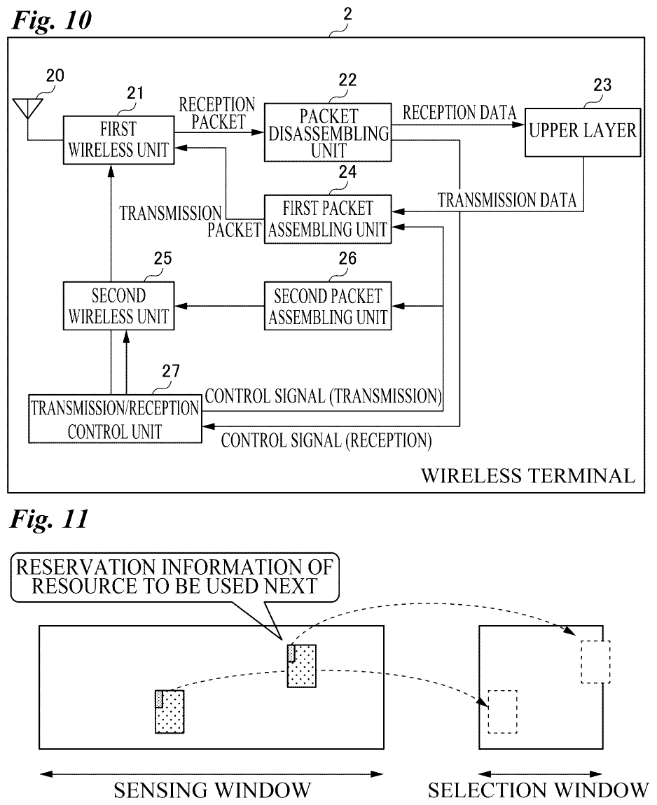

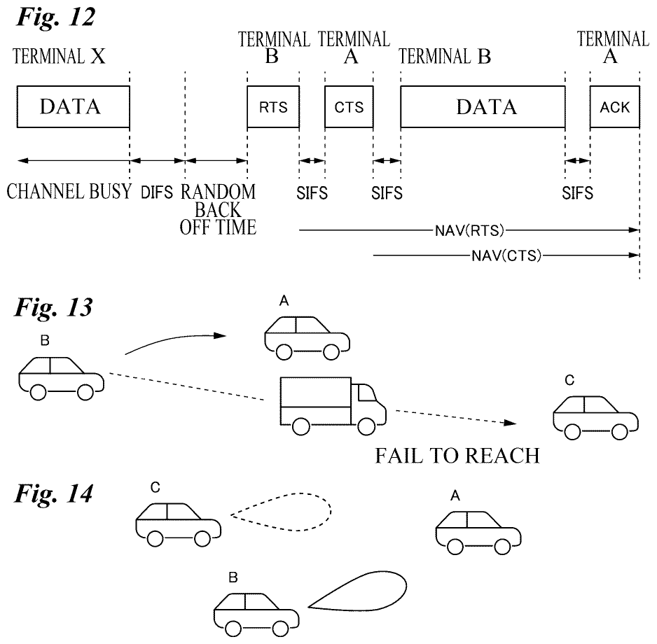

FIG. 10 is a block configuration diagram of a wireless terminal 2 in Embodiment 5. Note that the block configuration diagram illustrated in this FIG. 10 illustrates components that are the minimum necessary for producing an expected effect of the present invention, and does not illustrate other components for operating as the wireless terminal.

The wireless terminal 2 used in Embodiment 5 has a transmission/reception antenna 20, a first wireless unit 21, a packet disassembling unit 22, an upper layer 23, a first packet assembling unit 24, a second wireless unit 25, a second packet assembling unit 26, and a transmission/reception control unit 27 as illustrated in FIG. 10.

### <Embodiment 5 Wireless Terminal Description of Configuration>

As illustrated in FIG. 10, the wireless terminal 2 in the fifth embodiment is different in that the second wireless unit 25 and the second packet assembling unit 26 are included in addition to the wireless terminals in the first embodiment to the fourth embodiment. The wireless units in the first embodiment to the fourth embodiment correspond to the first wireless unit 21, and the packet disassembling units correspond to the first packet assembling unit 24. The following describes differences while omitting the descriptions of the common configurations in the wireless terminals.

The second packet assembling unit 26 and the second wireless unit 25 generate and transmit a transmission packet with a control signal including information of a radio resource planned to be received next in accordance with a wireless access method of wireless communication using a second frequency.

For example, a conventional wireless LAN or cellular wireless communication system is considered for the wireless access method of the wireless communication using the second frequency, and a beacon signal in those methods, a notification message transmitted by a wireless base station, or the like is transmitted. When the second frequency is a low frequency without the need of an antenna with a sharp directivity compared with the first frequency, the transmission packet including the control signal including the information of the radio resource planned to be received can be delivered to many wireless terminals even without transmitting many packets with many directivities.

### <Usage Example Providing Maximum Advantageous Effect of Invention>

Wireless terminals that perform wireless communication by sharing a frequency are generally low in price compared with terminals of a cellular wireless communication system that provides a communication service by exclusively using a frequency band provided for a permitted business operator; however, in a frequency band equal to or higher than a millimeter waveband for which the signal strength needs to be maintained using a directional antenna, a hidden node problem becomes more conspicuous, which may degrade the performance of the whole system. The present invention is to attempt to improve communication quality in a wireless system sharing a frequency, in particular, in a frequency band equal to or higher than a millimeter waveband, and is expected to expand the usage range of a low-priced wireless system sharing a frequency.

### DESCRIPTION OF REFERENCE SIGNS

1: Wireless terminal
1a: First wireless terminal
1b: Second wireless terminal
1c: Third wireless terminal
2: Wireless terminal
10: Transmission/reception antenna
11: Wireless unit
12: Packet disassembling unit
13: Upper layer
14: Packet assembling unit
15: Transmission/reception control unit
20: Transmission/reception antenna
21: First wireless unit
22: Packet disassembling unit
23: Upper layer
24: First packet assembling unit
25: Second wireless unit
26: Second packet assembling unit
27: Transmission/reception control unit

1. A wireless access method for a plurality of wireless terminals to communicate by sharing a frequency, comprising:
identifying a radio resource on which reception is planned to be performed, and transmitting a packet including information relating to the identified radio resource as a control signal, by a first wireless terminal; and
when a second wireless terminal has received the packet transmitted by the first wireless terminal and extracted the information of the radio resource on which the first wireless terminal plans to perform the reception, selecting one or a plurality of radio resources from remaining radio resources after removing the radio resource on which the first wireless terminal plans to perform the reception from a selection range of radio resources to be transmitted, and performing transmission, by the second wireless terminal.

2. The wireless access method according to claim 1, wherein
directivity of an antenna used when the first wireless terminal generates and transmits the transmission packet including the information relating to the radio resource on which the reception is planned to be performed as the control signal is identical or equivalent to directivity of an antenna planned to be used when the reception is performed on the radio resource on which the reception is planned to be performed.

3. The wireless access method according to claim 1, wherein
the directivity of the antenna planned to be used when the reception is performed on the radio resource on which the reception is planned to be performed by the first wireless terminal is a directivity directed to a counterpart of communication of the first wireless terminal.

4. A wireless terminal that communicates with another wireless terminal by sharing a frequency, wherein
the wireless terminal:
sets a range from which a radio resource for transmitting a packet is selected and a radio resource range for receiving a packet including information relating to a radio resource on which the other wireless terminal performs transmission as a control signal to detect presence/absence of a radio resource on which the other wireless terminal plans to perform reception among radio resources within the selection range of the radio resource for transmitting the packet;
performs the reception in the radio resource range for receiving the packet including the information relating to the radio resource as the control signal;
removes the detected radio resource on which the other wireless terminal plans to perform the reception from the selection range of the radio resources for transmission;
selects one or a plurality of radio resources from the remaining radio resource selection range; and
transmits the packet on the selected radio resource.

5. The wireless terminal according to claim 4, wherein
the wireless terminal generates and transmits a transmission packet including information relating to a radio resource on which reception is planned to be performed as a control signal when transmitting the packet.

6. The wireless terminal according to claim 5, wherein
directivity of an antenna used when the transmission packet including the information relating to the radio resource on which the reception is planned to be performed as the control signal is generated and transmitted is identical or equivalent to directivity of an antenna planned to be used when the reception is performed on the radio resource on which the reception is planned to be performed.
